(19) United States
(12) Patent Application Publication
(10) Pub. No.: US 2006/0169742 A1
(43) Pub. Date: Aug. 3, 2006

(54) Wire ultrasonic bonding method and wire ultrasonic bonding apparatus

(75) Inventors: Kei Fujimoto, Shizuoka (JP); Masanori Onuma, Shizuoka (JP)

Correspondence Address: MORGAN LEWIS & BOCKIUS LLP, 1111 PENNSYLVANIA AVENUE NW, WASHINGTON, DC, 20004, US

(73) Assignee: Yazaki Corporation

(21) Appl. No.: 11/302,503

(22) Filed: Dec. 14, 2005

(30) Foreign Application Priority Data
Dec. 16, 2004 (JP) 2004-364380

(51) Int. Cl. B23K 37/00; B23K 1/06; B23K 31/00

(52) U.S. Cl. 228/4.5; 228/1.1; 228/180.5

(57) ABSTRACT

A conductive portion of a wire, composed of a plurality of core wires, is inserted and fitted into a groove in a pressing die, thereby restricting the conductive portion to a bonding width of a terminal, and in this condition with the use of a press forming machine, the conductive portion is pressed in a thickness direction thereof to be formed into a flat shape. Thereafter, the conductive portion is inserted and fitted into the terminal, and then the conductive portion, while pressed by a pressing vibration horn, is bonded to the terminal by ultrasonic vibrations applied from the pressing vibration horn.

### BACKGROUND OF THE INVENTION

1. Field of the Invention

This invention relates to a wire ultrasonic bonding method and a wire ultrasonic bonding apparatus for bonding a wire (such as a stranded wire), having a plurality of core wires, to a connecting portion such as a terminal.

2. Related Art

A method of ultrasonic bonding a wire is already known (see, for example, Japanese Patent Publication No. JP-A-2004-095293, (Page 3 to 5)). FIGS. 3A through 4B are perspective views showing a wire ultrasonic bonding method disclosed in JP-A-2004-095293.

Referring to FIGS. 3A through 4B, in the wire ultrasonic bonding method, a conductive portion 102 (see FIG. 3A) of a wire 100, composed of a plurality of core wires 101 is restricted to a width corresponding to a bonding width W (see FIG. 4B) of a terminal 103, and in this condition the core wires 101 are ultrasonically bonded together (a first ultrasonic bonding operation) while applying a pressure to the core wires 101 in a thickness direction of the conductive portion 102 (see FIG. 3B), so that the conductive portion 102 is formed into an integral construction of a flat shape (see FIG. 4A). Thereafter, the conductive portion 102 is ultrasonically bonded (a second ultrasonic bonding operation) to the terminal 103 (see FIG. 4B).

In the above conventional wire ultrasonic bonding method, the core wires 101 are bonded together by the first ultrasonic bonding operation (see FIG. 3B) at the time when the conductive portion 102 of the wire 100 is formed into the flat shape, and therefore a good electrical performance of the bonded portion can be obtained.

However, large stresses due to the two ultrasonic bonding operations act on the conductive portion 102 of the wire 100, and this has invited a problem that the core wires 101 are liable to be cut. Namely, in the first ultrasonic bonding operation (see FIG. 3B), bonding stresses act in a concentrated manner on a portion of the wire 100 indicated by reference character A. In the second ultrasonic bonding operation (see FIG. 4B), bonding stresses further act in a concentrated manner on the portion A of the wire 100, and therefore there has been encountered a problem that the core wires 101 are liable to be cut because of the concentration of these bonding stresses.

### SUMMARY OF THE INVENTION

This invention has been made in view of the above circumstances, and an object of the invention is to provide a wire ultrasonic bonding method in which a conductor (core wires) is prevented from being cut during ultrasonic bonding of a wire, thereby providing the ultrasonically-bonded wire having excellent durability and reliability.

1) A wire ultrasonic bonding method of the present invention is characterized in that a conductive portion of a wire, composed of a plurality of core wires, is restricted to a width corresponding to a width of a connecting portion, and in this condition the conductive portion is pressed in a thickness direction thereof to be formed into a flat shape; and subsequently the conductive portion, while pressed, is bonded to the connecting portion by ultrasonic vibrations.

In the above wire ultrasonic bonding method, the conductive portion of the wire is restricted to the width corresponding to the width of the connecting portion, and in this condition the conductive portion is pressed into the flat shape, and thereafter the conductive portion is bonded to the connecting portion by ultrasonic vibrations. Therefore, there can be provided the wire ultrasonic bonding method in which the conductor (core wires) is prevented from being cut during the ultrasonic bonding of the wire, thereby providing the ultrasonically-bonded wire having excellent durability and reliability.

2) The wire ultrasonic bonding method of the above Paragraph 1) is further characterized in that the wire is made of a material which can be easily plastically deformed.

In the above wire ultrasonic bonding method, the wire is made of the material which can be easily plastically deformed, and therefore the pressed conductive portion of the wire can be smoothly and positively inserted and fitted into the connecting portion.

3) A wire ultrasonic bonding apparatus of the present invention is characterized in that the apparatus comprises a restricting member for restricting a conductive portion of a wire, composed of a plurality of core wires, to a predetermined width corresponding to a width of a connecting portion; a press forming machine for pressing the conductive portion of the wire, restricted to the predetermined width by the restricting member, in a width direction of the conductive portion to form the conductive portion into a flat shape; and pressing vibration member for bonding the pressed conductive portion of the wire, fitted in the connecting portion, to the connecting portion by ultrasonic vibrations while applying a pressure to the conductive portion.

In the above wire ultrasonic bonding apparatus, the conductive portion of the wire is restricted to the width corresponding to the width of the connecting portion by the restricting member, and in this condition the conductive portion is pressed into the flat shape by the press forming machine, and thereafter the conductive portion is bonded to the connecting portion by ultrasonic vibrations applied from the pressing vibration device. Therefore, there can be provided the wire ultrasonic bonding apparatus in which the conductor (core wires) is prevented from being cut during the ultrasonic bonding of the wire, thereby providing the ultrasonically-bonded wire having excellent durability and reliability.

4) The wire ultrasonic bonding apparatus of the above Paragraph 3) is further characterized in that the restricting member includes a die having a groove having a width corresponding to the width of the connecting portion, and when the conductive portion of the wire is inserted into the groove, the groove restricts the conductive portion to the predetermined width corresponding to the width of the connecting portion, and edges of the groove, disposed at that side from which the conductive portion of the wire is inserted into the groove, are chamfered or rounded into a predetermined curvature.

In the above wire ultrasonic bonding apparatus, the edges of the groove, disposed at that side from which the conductive portion of the wire is inserted into the groove, are chamfered or rounded into the predetermined curvature, and therefore there can be obtained the wire ultrasonic bonding apparatus in which the conductive portion of the wire can be smoothly and positively inserted and fitted into the groove in the die.

5) The wire ultrasonic bonding apparatus of the above Paragraph 3) or Paragraph 4) is further characterized in that the pressing vibration device includes a pressing vibration horn for bonding the pressed conductive portion of the wire, fitted in the connecting portion, to the connecting portion by ultrasonic vibrations while applying a pressure to the conductive portion, and a die which is located at that side of the connecting portion facing away from the pressing vibration horn, and supports the connecting portion so as to receive the pressure applied from the pressing vibration horn, and that portion of the die for contact with the connecting portion conforms in shape to the connecting portion.

In the above wire ultrasonic bonding apparatus, the portion of the die for contact with the connecting portion conforms in shape to the connecting portion, and therefore there can be obtained the wire ultrasonic bonding apparatus in which the high adhesion of the wire conductive portion to the connecting portion can be secured, so that the good bonding performance can be achieved.

In the wire ultrasonic bonding method and apparatus of the present invention, the conductor (core wires) is prevented from being cut during the ultrasonic bonding of the wire, and the control and facilities costs, required for the ultrasonic bonding operation effected at the time of the pressing operation, become unnecessary.

### BRIEF DESCRIPTION OF THE DRAWINGS

FIGS. 1A and 1B are perspective views of important portions showing a first stage of one preferred embodiment of a wire ultrasonic bonding method of the present invention, and FIG. 1A shows a wire which is already subjected to a sheath removing operation, but is not yet subjected to a bonding operation, and FIG. 1B shows the wire and a press forming machine for pressing a conductive portion of the wire into a flat shape;

FIGS. 2A and 2B are perspective views of important portions, showing a second stage (final stage) of the wire ultrasonic bonding method of the invention, and FIG. 2A shows the wire whose conductive portion is pressed into the flat shape by the press forming machine, and FIG. 2B shows the wire whose conductive portion, while pressed by a horn, is to be ultrasonically bonded to a terminal by the horn;

FIGS. 3A and 3B are perspective views of important portions showing a first stage of a conventional wire ultrasonic bonding method; and

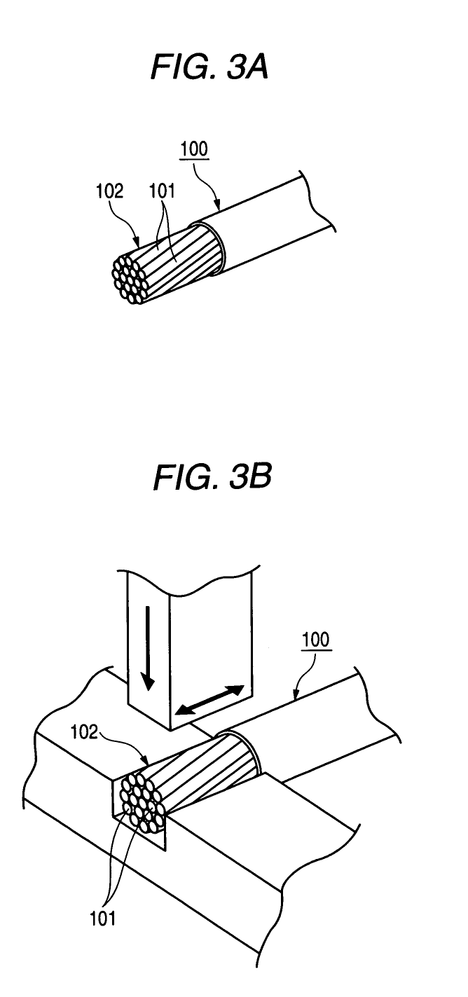

FIGS. 4A and 4B are perspective views of important portions, showing the conventional wire ultrasonic bonding method.

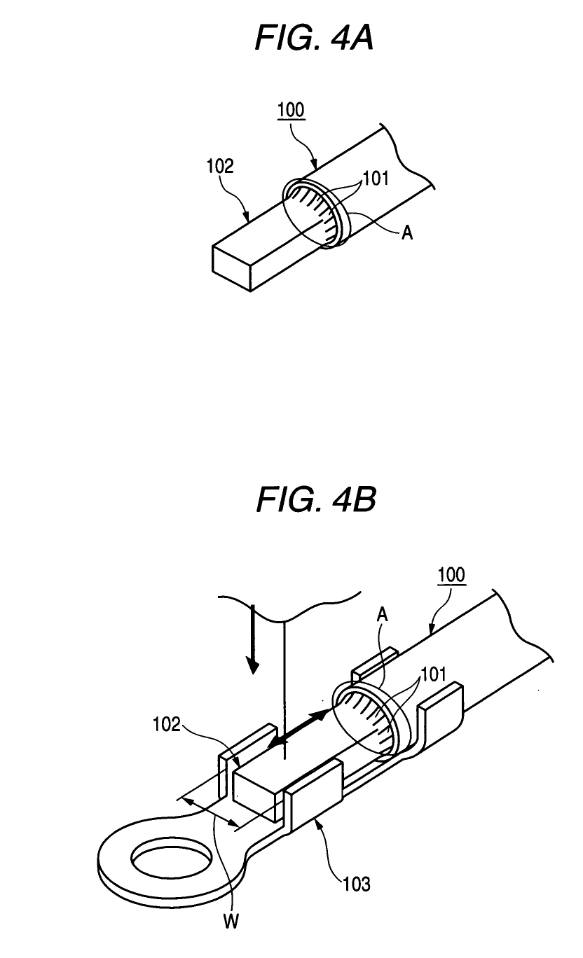

### DETAILED DESCRIPTION OF THE PREFERRED EMBODIMENTS

A preferred embodiment of the present invention will now be described.

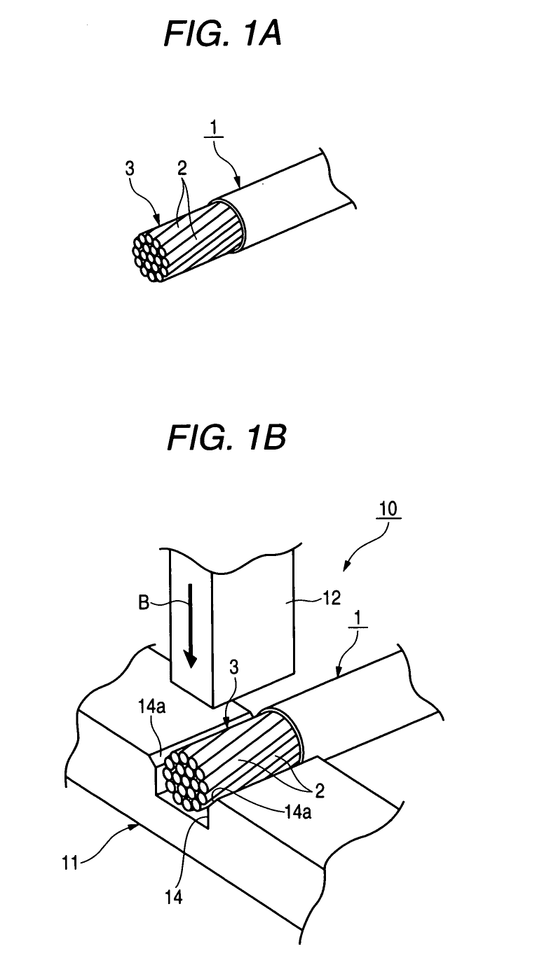

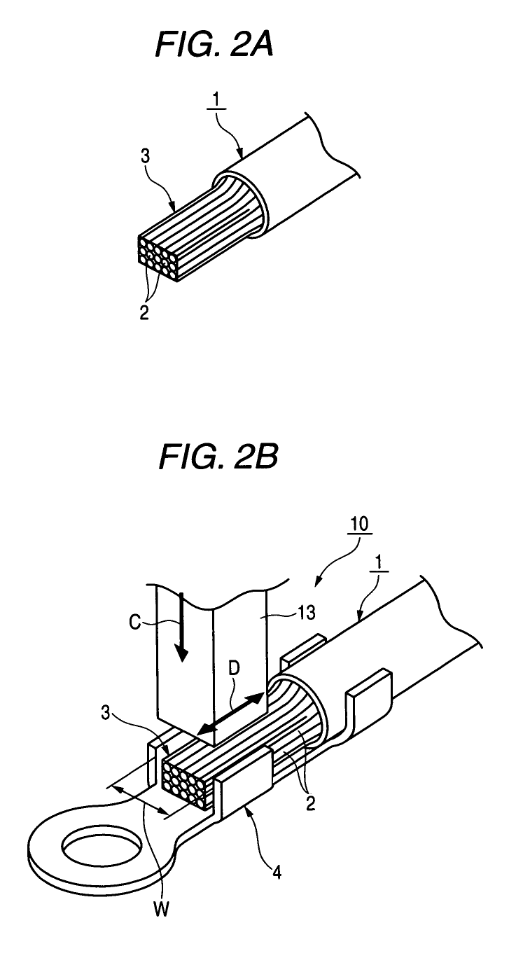

FIGS. 1A through 2B are perspective views of important portions, showing one preferred embodiment of a wire ultrasonic bonding method of the invention and a wire ultrasonic bonding apparatus of the invention, and FIG. 1A show a wire which is already subjected to a sheath removing operation, but is not yet subjected to a bonding operation, FIG. 1B shows the wire and a press forming machine for pressing a conductive portion of the wire into a flat shape, FIG. 2A shows the wire whose conductive portion is pressed into the flat shape by the press forming machine, and FIG. 2B shows the wire whose conductive portion, while pressed by a horn, is to be ultrasonically bonded to a terminal by the horn.

First, the wire ultrasonic bonding apparatus 10 for performing one preferred embodiment of the wire ultrasonic bonding method of the invention will be described with reference to FIGS. 1A through 2B.

The wire ultrasonic bonding apparatus 10 comprises a pressing die 11 for restricting the conductive portion 3 (composed of a plurality of core wires 2) of the wire 1 to a predetermined width corresponding to a bonding width W of the terminal 4 (serving as a connecting portion), the press forming machine 12 for pressing the conductive portion 3 of the wire 1, restricted to the predetermined width by the pressing die 11, in a thickness direction of the conductive portion 3, and the pressing vibration horn for ultrasonic bonding the pressed conductive portion 3 of the wire 1 to the terminal 4 while pressing this conductive portion 3.

A wire (e.g., an aluminum wire), made of a material which can be easily plastically deformed, is used as the wire 1.

More specifically, a conductor width-restricting groove 14 is formed in the pressing die 11, and this conductor width-restricting groove 14 has a width corresponding to the bonding width W of the terminal 4. When the conductive portion 3 of the wire 1 is inserted and fitted into the conductor width-restricting groove 14, this conductor width-restricting groove 14 restricts the conductive portion 3 to the width corresponding to the bonding width W of the terminal 4. Each of opposite side edges of the conductor width-restricting groove 14, disposed at that side from which the conductive portion 3 of the wire 1 is inserted into the conductor width-restricting groove 14, are chamfered or rounded into a predetermined curvature as at 14a. Thanks to the provision of the chamfered or rounded portions 14a, the conductive portion 3 of the wire 1 can be smoothly and positively inserted and fitted into the conductor width-restricting groove 14 in the pressing die 11.

The press forming machine 12 presses the conductive portion 3 of the wire 1, restricted to the predetermined width by the pressing die 11, in the width direction of the conductive portion 3 (see arrow B in FIG. 1B) to form this conductive portion 3 into the predetermined flat shape.

The pressed conductive portion 3 of the wire 1 is fitted in the terminal 4 as shown in FIG. 2B, and in this condition the pressing vibration horn 13, while pressing the conductive portion 3 (see arrow C in FIG. 2B), ultrasonically bonds this conductive portion 3 to the terminal 4 (see arrow D in FIG. 2B) supported on a die (not shown). That portion of the die and for contact with the terminal 4 conforms in shape to the terminal 4, and therefore the high adhesion of the conductive portion 3 of the wire 1 to the terminal 4 can be secured, so that the good bonding performance can be obtained.

Next, the wire ultrasonic bonding method of this embodiment will be described.

First, the sheath is removed from the end portion of the wire 1 to expose the conductive portion 3 composed of the plurality of core wires 2, as shown in FIG. 1A. Then, the exposed conductive portion 3 of the wire 1 is inserted and fitted into the conductor width-restricting groove 14 in the pressing die 11 as shown in FIG. 1B, thus restricting the conductive portion 3 to the predetermined width corresponding to the bonding width W of the terminal 4.

In this condition, with the use of the press forming machine 12, the conductive portion 3 of the wire 1 is pressed in the thickness direction thereof to be formed into the predetermined flat shape as shown in FIG. 2A. Thereafter, the pressed conductive portion 3 of the wire 1 is inserted and fitted into the terminal 4, and then this conductive portion 3, while pressed by the pressing vibration horn 13, is bonded to the terminal 4 by ultrasonic vibrations applied from the pressing vibration horn 13, as shown in FIG. 2B.

As described above, in the above embodiment, the conductive portion 3 of the wire 1, composed of the plurality of core wires 2, is inserted and fitted into the conductor width-restricting groove 14 in the pressing die 11, thereby restricting the conductive portion 3 to the predetermined width corresponding to the bonding width W of the terminal 4. In this condition, with the use of the press forming machine 12, the conductive portion 3 is pressed in the width direction thereof to be formed into the flat shape. Then, the pressed conductive portion 3 is inserted and fitted into the terminal 4, and then this conductive portion 3, while pressed by the pressing vibration horn 13, is bonded to the terminal 4 by ultrasonic vibrations applied from the pressing vibration horn 13.

Therefore, the number of times that the wire 1 is subjected to ultrasonic vibrations during the ultrasonic bonding of the wire 1 can be made one, and therefore the cutting of the conductor (the core wires 2) can be prevented. Therefore, there can be provided the ultrasonically-bonded wire 1 having excellent durability and reliability. And besides, the control and facilities costs, required for the ultrasonic bonding operation (the conventional first ultrasonic bonding operation) effected at the time of the pressing operation in the conventional method, become unnecessary.

The wire ultrasonic bonding method and apparatus of the present invention can be suitably used for ultrasonic bonding a stranded wire.

What is claimed is:

1. A wire ultrasonic bonding method wherein a conductive portion of a wire provided with a plurality of core wires is connected to a connecting portion, comprising the steps of:
pressing the conductive portion in a thickness direction of the connecting portion so as to be formed into a flat shape in a condition that the conductive portion is restricted to a width corresponding to a width of the connecting portion; and
inserting the conductive portion into the connecting portion; and
bonding the conductive portion to the connecting portion by ultrasonic vibrations while further applying a pressure to the conductive portion.

2. A wire ultrasonic bonding method according to claim 1, wherein said wire is made of a material which is plastically deformable easily.

3. A wire ultrasonic bonding apparatus comprising:
a restricting member for restricting a conductive portion of a wire provided with a plurality of core wires to a predetermined width corresponding to a width of a connecting portion;
a press forming machine for pressing said conductive portion of said wire that is restricted to said predetermined width by said restricting member, in a width direction of said conductive portion to form said conductive portion into a flat shape; and
a pressing vibration device for bonding said pressed conductive portion of said wire, fitted in said connecting portion, to said connecting portion by ultrasonic vibrations while applying a pressure to said conductive portion.

4. A wire ultrasonic bonding apparatus according to claim 3, wherein said restricting member includes
a die having a groove having a width corresponding to the width of said connecting portion,
when said conductive portion of said wire is inserted into said groove, said groove restricts said conductive portion to the predetermined width, and
edges of said groove, disposed at a side from which said conductive portion of said wire is inserted into said groove, are chamfered or rounded into a predetermined curvature.

5. A wire ultrasonic bonding apparatus according to claim 3, wherein said pressing vibration device includes
a pressing vibration horn for bonding said pressed conductive portion of said wire, fitted in said connecting portion, to said connecting portion by ultrasonic vibrations while applying a pressure to said conductive portion, and
a die which is located at a side of said connecting portion facing away from said pressing vibration horn, and supports said connecting portion so as to receive the pressure applied from said pressing vibration horn, and a portion of said die for contact with said connecting portion conforms in shape to said connecting portion.
